(19) United States
(12) Patent Application Publication
(10) Pub. No.: US 2022/0134918 A1
(43) Pub. Date: May 5, 2022

(54) COVER FOR AN UPHOLSTERED PART OF A VEHICLE SEAT, UPHOLSTERED PART FOR A VEHICLE SEAT, AND VEHICLE SEAT

(71) Applicant: Adient Engineering and IP GmbH, Burscheid (DE)

(72) Inventors: Anna OLSSON, Partille (SE); Wim DOSSCHE, Eeklo (BE); Claus STENING, Romelanda (SE); Stefan J. CARLSSON, Goeteborg (SE)

(73) Assignee: Adient Engineering and IP GmbH, Burscheid (DE)

(21) Appl. No.: 17/433,293

(22) PCT Filed: Feb. 24, 2020
(86) PCT No.: PCT/EP2020/054793

§ 371 Date: Aug. 24, 2021

(30) Foreign Application Priority Data
Feb. 25, 2019 (DE) 10 2019 104 762.5

(51) Int. Cl. B60N 2/28; B60N 2/58

(52) U.S. Cl. CPC B60N 2/2887; B60N 2/58

(57) ABSTRACT

A cover for an upholstered part of a vehicle seat having at least one opening, in particular a through opening for a locking device for a child seat. An edge area of the cover arranged around the at least one opening is reinforced at least in sections with a reinforcing frame made from a plastic material. An upholstered part for a vehicle seat, in particular a motor vehicle seat, having the cover and the vehicle seat having at least one such upholstered part are also provided.

The invention relates to a cover for a cushion part of a vehicle seat, the cover having at least one opening, in particular in the form of a through-opening for a locking device of a child seat. The invention also relates to a cushion part for a vehicle seat and to a vehicle seat.

### PRIOR ART

Fastening devices for fastening a child seat to a vehicle seat are known from the prior art. In the case of what is known as an ISOFIX fastening device, two fastening elements which are connected at least indirectly to the vehicle seat interact with two locking devices, what are known as connectors, of the child seat. For this purpose, the fastening device has the two fastening elements which are at the same spacing from one another as the connectors of the child seat. Each fastening element is preferably in the form of a bracket in accordance with the ISOFIX standard, and preferably consists of a wire which is bent multiple times and has a circular cross section of approximately constant diameter.

DE 100 04 598 A1 discloses a fastening device for fastening a child seat to a vehicle seat, in the case of which fastening device a fastening element is in the form of a bent wire which has two ends which are fastened to a crossmember of a seat substructure. The crossmember is a tube.

DE 10 2008 009 575 A1 has disclosed a fastening device for fastening a child seat to a vehicle seat, comprising a carrier and a bracket, the bracket having at least one first fastening portion, one second fastening portion and one web, and the first and the second fastening portion being separate from one another and being connected in each case fixedly to the carrier. The web connects the first and the second fastening portion to one another, the bracket being of single-part form. The bracket is a shaped, flat metal sheet. The web has a C-shaped cross section.

The fastening device serves to hook a fastening hook, which is attached to one end of a belt, the other end of which is fastened to an upper region of a child seat, on the rear side of a vehicle backrest, and in this way to secure the child seat. The belt with the hook is also referred to as a top tether. Such top tethers are used in particular in the USA and Canada for fastening child seats to the vehicle structure.

DE 198 53 149 C1 discloses a vehicle seat, to which a child seat can be attached by a fastening device which is arranged on the vehicle seat between a seat cushion and a backrest. The fastening device can be concealed by a covering when not in use. That side of the covering which faces away from the fastening device forms a part of the seat surface of the vehicle seat.

US 2016/0200224 A1, US 2016/0250948 A1, US 2016/0325658 A1, CN 108177567 A and CN 108189719 A have also disclosed coverings for fastening devices for fastening a child seat to a vehicle seat.

EP 1 352 779 A1 has disclosed a control lever assembly for use in a vehicle seat which is covered with a textile cover. The control lever assembly has a device for changing the mechanical state of a system for controlling the position of the vehicle seat, and a flange for surrounding the device for changing the mechanical state.

DE 10 2006 058 388 A1 discloses a method for mounting an actuating device for a vehicle, having a base part, a bezel, a handle piece and at least one Bowden cable with an end fitting, the base part having a first collar and the bezel having a second collar, a clamping gap being produced during mounting between the first collar and the second collar, and a cover being clamped in the clamping gap. The cover is pulled over the base part, the cover having a recess which lies above the chamber of the base part, and the tab of the cover being guided around the inner periphery of the first collar and being pushed by the slot onto the lug, which produces a form-fitting connection.

### Problem

The invention is based on the problem of improving a cover for a vehicle seat, the cover having at least one through-opening, which can be closed by a covering. In particular, the intention is to provide the option of a high-quality configuration for an edge region of the cover that delimits the through-opening. The intention is to prevent the edge region of the cover from being able to detach from the covering in such a way that the edge region is visible. In addition, a cushion part with a corresponding cover should have a high impression of quality.

### Solution

This problem is solved according to the invention by a cover for a cushion part of a vehicle seat, the cover having at least one opening, in particular in the form of a through-opening for a locking device of a child seat, an edge region of the cover that is arranged around the at least opening being reinforced at least in certain portions with a reinforcing frame.

Since an edge region of the cover that is arranged around the at least one opening is reinforced at least in certain portions with a reinforcing frame, the edge regions of the cover are prevented from being able to detach from the covering in such a way that these edge regions are visible. The cover is stiffened in the edge regions surrounding the at least one opening, as a result of which the edge regions have less of a tendency to be pulled out from under an edge of the covering in the event of high cover tension.

The reinforcing frame is produced, preferably folded, from a plastics material. The plastics material is a textile sheet material composed of an unordered fiber material which can be separated only with difficulty. The plastics material is therefore a non-woven textile. The material thickness of the plastics material is for example in a range of between 1 mm and 5 mm, preferably approximately 3 mm.

The subclaims relate to advantageous embodiments, which may be used individually or in combination with one another.

The reinforcing frame may be arranged on a rear side of the cover.

The reinforcing frame may have a U-shaped form. The reinforcing frame may have a web and two legs. The web may be connected to at least one of the two legs by at least one hinge. The hinge may be in the form of a film hinge.

The reinforcing frame may be folded from a plastics material with a material thickness of between 1 mm and 5 mm, preferably between 2 mm and 4 mm. A depth of the reinforcing frame may be at least three times greater, preferably at least ten times greater, than the material thickness of the plastics material.

The reinforcing frame may be sewn to the cover by at least one seam. The cover may have at least one tab in at least one edge region adjoining the opening. The at least one tab may be turned over in the direction of a rear side of the cover and may be sewn to the cover (100) and/or to the reinforcing frame. The reinforcing frame may have been pressed into the opening, in particular folded into the opening.

The problem is also solved by a cushion part for a vehicle seat, in particular a motor vehicle seat, having a cover according to the invention. A cushion part with a cover according to the invention has a high impression of quality.

The problem is also solved by a vehicle seat with at least one such cushion part.

A covering, which is pushed through the opening in the cover, preferably has an edge. The edge preferably conceals that region of the front side of the cover which is reinforced by the plastics material on the rear side of the cover, such that regions of the front side of the cover in which the reinforcing frame could cause impressions in a top layer of the cover and/or seams by way of which the plastics material is sewn to the cover are not visible.

### FIGURES AND EMBODIMENTS OF THE INVENTION

The invention is explained in more detail below on the basis of two vehicle seats, which are illustrated in FIGS. 1 to 5 and known from the prior art, a child seat, which is illustrated in FIG. 1 and known from the prior art, and two advantageous exemplary embodiments, which are illustrated in FIGS. 6 to 12. However, the invention is not restricted to these exemplary embodiments. In the figures:

FIG. 1: shows a diagrammatic side view of a vehicle seat according to the invention with a child seat which is fastened to the vehicle seat,

FIG. 2: shows details of a front view of a vehicle seat which is known from the prior art, the detail showing a bolster of a seat part that is arranged in a transition region between the seat part and a backrest,

FIG. 3: shows a view of a detail from FIG. 2 of a covering for closing a through-opening to a fastening element for fastening a child seat,

FIG. 4: shows a view, corresponding to FIG. 3, of a detail of a cushion part of the vehicle seat with the covering removed,

FIG. 5: shows a rear view of the covering,

FIG. 6: shows details of a view of a rear side of a cover according to the invention in the region of an opening that is reinforced with a reinforcing frame,

FIG. 7: shows details of a view of a front side of the cover from FIG. 6 in the region of the opening, before the cover has been pressed into a through-opening, in particular folded into a through-opening,

FIG. 8: shows details of a view of a front side of the cover from FIG. 6 in the region of the opening, after the cover has been pressed into the through-opening, and

FIG. 9: shows details of a view of a front side of the cover from FIG. 6 in the region of the opening, after the cover has been pressed into the through-opening and the cover has been applied to the foam part.

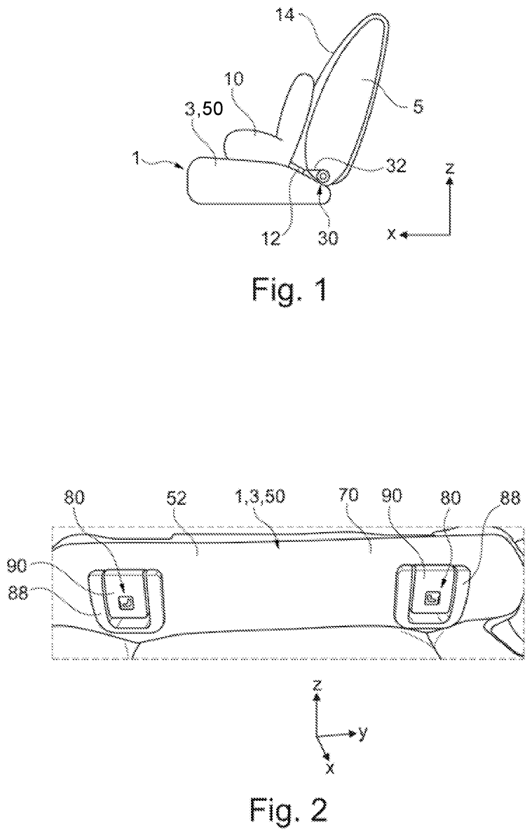

FIG. 1 shows a schematic illustration of an arrangement consisting of a vehicle seat 1 according to the invention for a motor vehicle and a child seat 10 which is known from the prior art, designed in particular as an ISOFIX child seat. The vehicle seat 1 has a seat part 3 and a backrest 5.

The seat part 3 has a load-bearing structure which comprises a fastening device 30 for fastening the child seat 10 to the vehicle seat 1. The fastening device 30 has two lower fastening elements 32 for fastening the child seat 10 which can be placed onto the vehicle seat 1. The fastening elements 32 are preferably bent steel wires which are fastened to a load-bearing structure of the vehicle seat 1, in particular the seat part 3, or to a load-bearing structure of the motor vehicle.

The child seat 10 can be fastened to the two fastening elements 32. To this end, the child seat 10 has two locking devices 12, also referred to as connectors, which project toward the rear in the lower region of the child seat 10 and can be locked to the fastening elements 32.

In addition, a further fastening means may be provided on the vehicle seat 1, to which further fastening means a safety belt 14 (also referred to as top tether), which is known from the prior art, of the child seat 10 can be fastened. The safety belt 14 is fastened in the upper region of the child seat 10, is deflected over an upper edge of the backrest 5, and is guided downward behind the backrest 5, where it can be fastened to the further fastening means of the vehicle seat 1 or the vehicle structure.

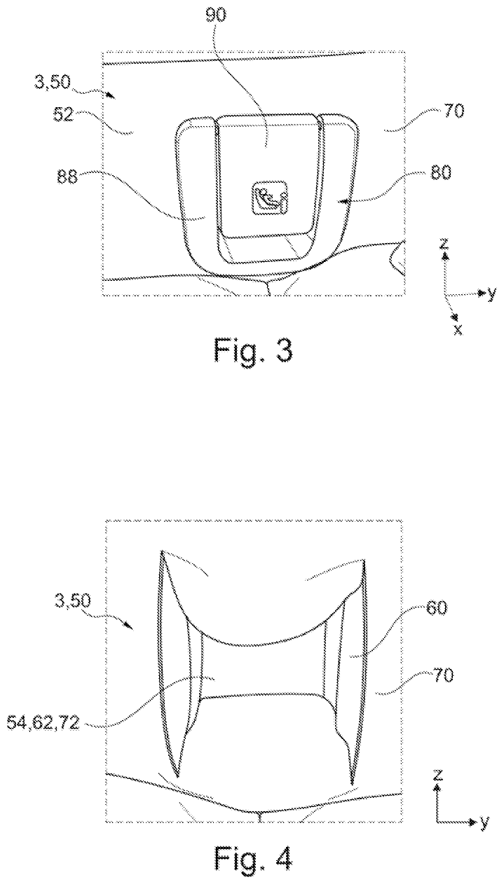

FIGS. 2 to 5 show a cushion part 50 of a seat part 3 of a vehicle seat 1 which is known from the prior art and in the present case is in the form of a rear seat. A front seat can be of analogous construction. The vehicle seat 1 has the seat part 3 and a backrest.

The vehicle seats 1 and the invention will be described below with the use of three spatial directions which run perpendicularly with respect to one another. In the case of a vehicle seat 1 installed in the vehicle, a longitudinal direction x runs largely horizontally and preferably parallel to a vehicle longitudinal direction which corresponds to the normal direction of travel of the vehicle. A transverse direction y which runs perpendicularly with respect to the longitudinal direction x is likewise oriented horizontally in the vehicle and runs parallel to a vehicle transverse direction. A vertical direction z runs perpendicularly with respect to the longitudinal direction x and perpendicularly with respect to the transverse direction y. In the case of a vehicle seat 1 which is installed in the vehicle, the vertical direction z runs parallel to the vehicle vertical axis.

The positional and directional specifications which are used, such as for example front, rear, top and bottom, relate to a viewing direction of an occupant seated in the vehicle seat 1 in a normal seating position, the vehicle seat 1 being installed in the vehicle and being oriented in a use position which is suitable for passenger transportation with an upright backrest 5 and, as is customary, in the direction of travel, without a child seat 10 being mounted. The vehicle seat 1 according to the invention may also be installed, however, in a differing orientation, for example transversely with respect to the direction of travel.

The seat part 3 has a seat frame which supports the cushion part 50. The cushion part 50 comprises a foam part 60 and a cover 70. The foam part 60 is provided with the cover 70, which has a top layer, for example composed of a fabric, an artificial leather or a leather. The seat frame can preferably be connected to a vehicle structure of the vehicle.

A fastening device, not illustrated in FIGS. 2 to 5, for fastening a child seat 10 on the vehicle seat 1 comprises two lower fastening elements 32 for fastening a child seat 10 which can be placed on the vehicle seat 1. The fastening elements 32 are preferably bent steel wires which are connected fixedly to the vehicle structure of the vehicle, into which the vehicle seat 1 can be installed. In one modification of the exemplary embodiment, the fastening elements 32 are a constituent part of the seat frame.

The fastening elements 32 of the fastening device 30 are arranged behind a bolster 52 of the cushion part 50, which bolster adjoins the backrest. The cushion part 50, in the present case the bolster 52, has two through-openings 54 per seating position. The through-openings 54 are formed by way of corresponding through-holes 62 in the foam part 60, and corresponding openings 72 in the cover 70. The through-openings 54 allow locking devices 12 of the child seat 10 to be guided through the cushion part 50 and to be locked to the fastening elements 32. The fastening elements 32 may be arranged behind the respectively associated through-opening 54 or in the respectively associated through-opening 54.

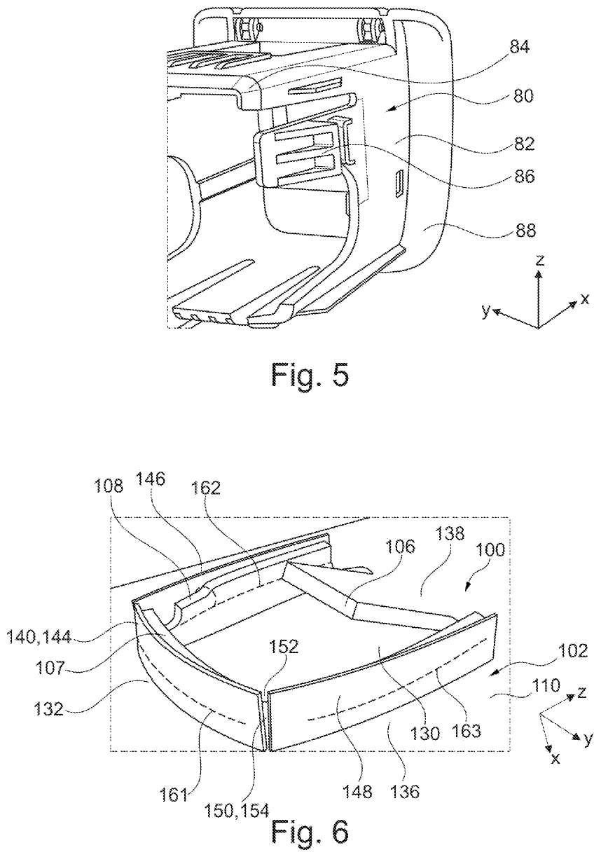

The through-openings 54 in the cushion part 50 are concealed in each case by way of a covering 80, illustrated for example in FIG. 5, or a differently configured covering. In addition, the coverings 80 serve to respectively line the through-openings 54 in the cushion part 50. Each of the two coverings 80 has a carrier 82 and a flap 90, which is pivotably mounted on the carrier. When the flap 90 is in a closed state, it closes the through-opening 54 assigned to the covering. By pivoting the flap 90 about a pivot axis running parallel to the transverse direction y, the flap 90 opens up the through-opening 54 such that the fastening element arranged behind the flap 90 is accessible.

The carrier 82 is of a frame-shaped configuration. The carrier 82 has a largely tubular basic shape with an approximately rectangular cross section. The carrier 82 is manufactured from plastic. The carrier 82 has a plurality of centering means 84 for centering the carrier 82 on the seat frame, for example in an opening of a retaining plate of the seat frame, or on a corresponding retaining plate of the vehicle structure of the vehicle. In addition, the carrier 82 has a plurality of clips 86 for fastening the carrier 82 to the seat frame, for example in an opening of a retaining plate of the seat frame, or to a corresponding retaining plate of the of the vehicle structure of the vehicle.

The carrier 82 has an edge 88 which projects outwardly around the periphery of the through-opening 54 and conceals edge regions of the cover 70 around the periphery of the opening 72.

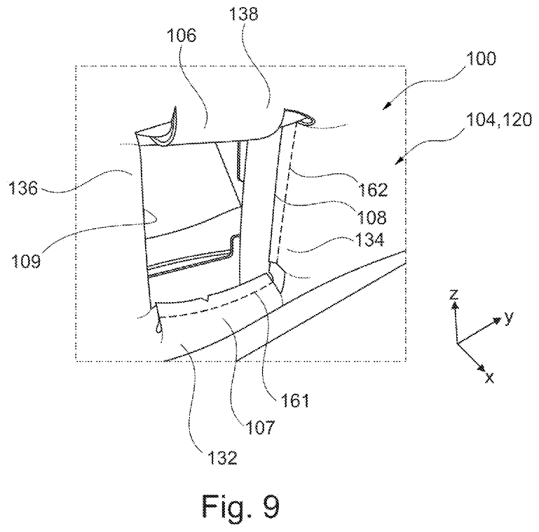

FIGS. 6 to 9 show an exemplary embodiment of a cover 100 according to the invention. In comparison with the cover 70 known from the prior art, this cover 100 has a design in the edge regions around the through-openings that is reinforced by a reinforcing frame 140 composed of a plastics material. The cover 100 according to the invention can replace the cover 70 known from the prior art without it being necessary to make changes to further components of the cushion part 50 which is known from the prior art. In particular, the foam part 60 and the covering 80 can be combined unchanged with the cover 100 according to the invention. The cover 100 may consist of a plurality of cover parts which are connected to one another, preferably sewn to one another.

Unless described otherwise, the cover 100 according to the invention corresponds to the previously described cover 70 which is known from the prior art.

FIGS. 6 to 9 show the cover according to the invention. The cover 100 is a constituent part of a cushion part for a vehicle seat 1. A foam part of the cushion part is covered by the cover 100. The cover 100 may be sewn together from a plurality of cover parts.

FIG. 6 shows a view of a rear side 102 of the cover 100. The rear side 102 of the cover 100, which is also technically referred to as the B side, is that side of the cover 100 which faces a foam part. In the completely upholstered state of the cushion part in the vehicle seat 1, the rear side 102 of the cover 100 is not visible to the user of the vehicle seat 1.

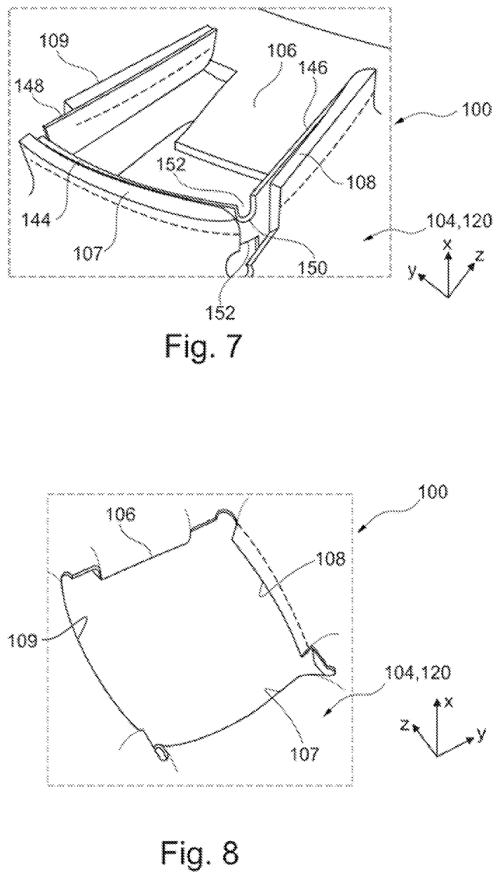

FIG. 7 shows a view of a front side 104 of the cover 100. The front side 104 of the cover 100, which is also technically referred to as the A side, is that side of the cover 100 which faces the user of the vehicle seat 1. In the completely upholstered state of the cushion part in the vehicle seat 1, the front side 104 of the cover 100 is largely visible to the user of the vehicle seat 1 and is partially in contact with the body of the user.

In the present case, the cover 100 has two cover layers. A textile carrier layer 110, in particular a woven fabric, is provided with a top layer 120, in particular a vinyl layer. The carrier layer 110 and the top layer 120 are connected to one another over their surface area and constitute an artificial leather, that is to say an imitation leather. In this respect, the top layer 120 forms the front side 104 and the carrier layer 110 forms the rear side 102 of the cover 100.

In modifications of the exemplary embodiment, further cover layers, for example a knitted spacer fabric and/or a ventilation layer, may be arranged between the top layer 120 and the carrier layer 110. In further modifications of the exemplary embodiment, the top layer consists for example of a textile material or an animal skin, in particular a leather. The invention is not limited to an artificial leather cover in this respect.

The cover 100 has two openings 130. The openings 130 together with through-holes in the foam part form the through-openings of the cushion part. The through-openings of the cushion part allow the locking devices 12 of a child seat 10 to be guided through the cushion part 50 and to be locked to fastening devices.

In the region of the two openings 130, the structure of the cover 100 is preferably respectively the same, if appropriate mirror-symmetrical with respect to a plane of symmetry running perpendicularly with respect to the transverse direction y, which is why only one opening 130 is described below.

An edge region of the cover 100 that delimits the opening 130 is reinforced in certain portions with the reinforcing frame 140, which is composed of plastics material. The plastics material 140 is folded from a flat sheet blank 142 to form the reinforcing frame 140. The reinforcing frame 140 has a U-shaped contour. The reinforcing frame 140 has a web 144 and two legs 146, 148. The web 144 and the two legs 146, 148 are respectively largely perpendicular with respect to the rear side 102 of the cover 100.

The web 144 is connected to the two legs 146, 148 by way of a flexible hinge 150 in each case. In the present case, the hinge 150 is formed by two notches 152 and a film hinge 154 (a flexible, thin-walled joint channel) in the plastics material.

The depth of the web 144, measured parallel to the longitudinal direction x, is greater than the material thickness of the plastics material. The depth of the web 144, measured parallel to the longitudinal direction x, is at least three times greater, preferably at least ten times greater, than the material thickness of the plastics material. The depth of the two legs 146, 148, measured parallel to the longitudinal direction x, is greater than the material thickness of the plastics material in each case. The depth of the two legs 146, 148, measured parallel to the longitudinal direction x, is at least three times greater, preferably at least ten times greater, than the material thickness of the plastics material in each case.

The opening 130 is delimited by a lower edge region 132, a first lateral edge region 134, a second lateral edge region 136 and an upper edge region 138. The edge regions 132, 134, 136, 138 are edge regions of the cover 100 that adjoin the opening 130. The lower edge region 132 and the upper edge region 138 preferably run parallel to one another and parallel to the transverse direction y. The two lateral edge regions 134, 136 preferably run parallel to one another and largely parallel to the vertical direction z.

In the transverse direction y, a first tab 106 of the cover 100 has a width which is smaller than the spacing between the first lateral edge region 134 and the second lateral edge region 136. The first tab 106 is integrally connected to the rest of the cover 100 in an upper edge region 138, which delimits the opening 130. The first tab 106 may be pivoted about the upper edge region 138. The first tab 106 is integrally connected to the rest of the cover 100 in the upper edge region 138, which delimits the opening 130. During the mounting of a vehicle seat 1 which has the cover 100, by virtue of pushing the covering into the opening 130 the tab 106 is folded over by approximately 90 degrees and arranged between the covering and the foam part.

In the transverse direction y, a second tab 107 of the cover 100 has approximately a width which corresponds to the spacing between the first lateral edge region 134 and the second lateral edge region 136. The second tab 107 is integrally connected to the rest of the cover 100 in the lower edge region 138.

In the transverse direction y, a second tab 107 of the cover 100 has approximately a width which corresponds to the spacing between the first lateral edge region 134 and the second lateral edge region 136. The second tab 107 is integrally connected to the rest of the cover 100 in the lower edge region 138. The second tab 107 is turned about the lower edge region 132 by approximately 90 degrees and sewn to the web 144 by a first seam 151.

In the vertical direction z, a third tab 108 of the cover 100 has a smaller height than that corresponding to the spacing between the lower edge region 132 and the upper edge region 138. The third tab 108 is integrally connected to the rest of the cover 100 in the first lateral edge region 134. The third tab 108 is spaced apart both from the lower edge region 132 and from the upper edge region 138. The third tab 108 is pivoted about the first lateral edge region 134 in the direction of the rear side 102 of the cover 100 and is sewn to the first leg 146 of the reinforcing frame 140 by a second seam 162.

In the vertical direction z, a fourth tab 109 of the cover 100 has a smaller height than that corresponding to the spacing between the lower edge region 132 and the upper edge region 138. The fourth tab 108 is integrally connected to the rest of the cover 100 in the second lateral edge region 134. The fourth tab 109 is spaced apart both from the lower edge region 132 and from the upper edge region 138. The fourth tab 108 is pivoted about the second lateral edge region 136 in the direction of the rear side 102 of the cover 100 and is sewn to the second leg 148 of the reinforcing frame 140 by a third seam 164.

The features which are disclosed in the above description, in the claims and in the figures can be of significance both individually and in combination for the implementation of the invention in its various embodiments, in so far as they remain within the scope of protection of the claims.

### LIST OF REFERENCE DESIGNATIONS

1 Vehicle seat
3 Seat part
5 Backrest
10 Child seat
12 Locking device
14 Safety belt
30 Fastening device
32 Fastening element
50 Cushion part
52 Bolster
54 Through-opening
60 Foam part
62 Through-hole
70 Cover
72 Opening
80 Covering
82 Carrier
84 Centering means
86 Clip
88 Edge
90 Flap
100 Cover
102 Rear side (B side)
104 Front side (A side)
106 First tab
107 Second tab
108 Third tab
109 Fourth tab
110 Carrier layer
120 Top layer
130 Opening
132 Lower edge region
134 (First) lateral edge region
136 (Second) lateral edge region
138 Upper edge region
140 Reinforcing frame
144 Web
146 Leg
148 Leg
150 Hinge
152 Notch
154 Film hinge
161 (First) seam
162 (Second) seam
163 (Third) seam
x Longitudinal direction
y Transverse direction
z Vertical direction

1-15. (canceled)

16. A cover for a cushion part of a vehicle seat, the cover having at least one opening in the form of a through-opening for a locking device of a child seat, wherein an edge region of the cover that is arranged around the at least one opening is reinforced at least in certain portions with a reinforcing frame.

17. The cover as claimed in claim 16, wherein the reinforcing frame is arranged on a rear side of the cover.

18. The cover as claimed in claim 16, characterized in that the reinforcing frame has a U-shaped form, in particular has a web and two legs.

19. The cover as claimed in claim 18, wherein the web is connected to at least one of the two legs by at least one hinge.

20. The cover as claimed in claim 19, wherein the hinge is in the form of a film hinge.

21. The cover as claimed in claim 16, wherein the reinforcing frame is folded from a plastics material with a material thickness of between 1 mm and 5 mm including between 2 mm and 4 mm.

22. The cover as claimed in claim 16, wherein a depth of the reinforcing frame is at least three times greater, including at least ten times greater, than the material thickness of the plastics material.

23. The cover as claimed in claim 16, wherein the reinforcing frame is sewn to the cover by at least one seam.

24. The cover as claimed in claim 16, wherein the cover has at least one tab in at least one edge region adjoining the opening.

25. The cover as claimed in claim 24, wherein the at least one tab is turned over in the direction of a rear side of the cover and sewn to the cover and/or to the reinforcing frame.

26. The cover as claimed in claim 16, wherein the reinforcing frame has been pressed into the opening, including folded into the opening.

27. A cushion part for a vehicle seat having a cover as claimed in claim 16.

28. The cushion part as claimed in claim 27, wherein the reinforcing frame has been pressed into the through-opening, including folded into the through-opening.

29. The cushion part as claimed in claim 28, wherein the cushion part has a bolster, and the at least one opening is arranged in the region of the bolster.

30. A vehicle seat with at least one cushion part as claimed in claim 29.
